(19) United States
(12) Patent Application Publication
(10) Pub. No.: US 2025/0371951 A1
(43) Pub. Date: Dec. 4, 2025

(54) CENTRAL SECURITY SYSTEM

(71) Applicant: Alarm.com Incorporated, Tysons, VA (US)

(72) Inventors: Adam Brandfass, Pittsburgh, PA (US); Mike Roth, Webster Groves, MO (US); Zach Winkler, Austin, TX (US)

(21) Appl. No.: 19/220,870

(22) Filed: May 28, 2025

Related U.S. Application Data
(60) Provisional application No. 63/654,347, filed on May 31, 2024.

(51) Int. Cl. G08B 13/16; G06F 40/205

(52) U.S. Cl. CPC G08B 13/1672; G06F 40/205

(57) ABSTRACT

Methods, systems, and apparatus, including computer programs encoded on computer storage media, for performing security-related actions for a property. One of the methods includes accessing data from a responder data stream that encodes speech for an event at a property; detecting the speech for the event at the property, the detecting comprising parsing the data from the responder data stream; determining one or more actions to perform using the detected speech for the event at the property; and performing, for the property, the one or more actions.

### CROSS-REFERENCE TO RELATED APPLICATION

This application claims the benefit of U.S. Provisional Application No. 63/654,347, filed May 31, 2024, the contents of which are incorporated by reference herein.

### BACKGROUND

This specification relates to systems for monitoring properties such as residential houses or corporate buildings where security systems are installed. Security systems can include sensors and controllers to track motion and activities.

### SUMMARY

In general, one innovative aspect of the subject matter described in this specification can be embodied in methods that include the actions of accessing data from a responder data stream that encodes speech for an event at a property; detecting the speech for the event at the property, the detecting including parsing the data from the responder data stream; determining one or more actions to perform using the detected speech for the event at the property; and performing, for the property, the one or more actions.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or can cause the system to perform the actions. One or more computer programs can be configured to perform particular operations or actions by virtue of including instructions that, when executed by the data processing apparatus, cause the apparatus to perform the actions.

The foregoing and other implementations can each optionally include one or more of the following features, alone or in combination.

In some implementations, determining the one or more actions to perform can include determining a type of the event at the property, and in response to determining the type of the event, determining, using the type of the event, i) a first action of the one or more actions to be performed for the property and ii) an object as a designated target for the first action.

In some implementations, accessing the data from the responder data stream that encodes the speech for the event can include determining a time stamp of the event for the property, the time stamp being obtained from a component of a monitoring system at the property and identifying the data to be accessed as data within a predefined time range around the time stamp of the event.

In some implementations, the method can include receiving a message that indicates the event at the property and includes an identifier for the property that has a monitoring system; and determining a responder system for the property using the identifier for the property. Determining the one or more actions can include determining, using the detected speech for the event at the property, a first action for the responder system to perform in response to the event, and performing the one or more actions for the property including sending an instruction to the responder system to cause the responder system to perform the first action that would not otherwise be performed by the responder system.

In some implementations, the method can include providing, to a first responder system, an alarm about the event. Determining the one or more actions can include predicting a response for the first responder system given the event using the detected speech for the event at the property, determining that the response for the first responder system does not satisfy one or more response criteria, in response to determining that the response for the first responder system does not satisfy the one or more response criteria, predicting an action for a second responder system that satisfies the one or more response criteria, and providing, to the second responder system, instructions for the first action.

In some implementations, predicting the action can include performing data analytics over historical data associated with responder systems designated for an area that includes the property and the detected speech for the event at the property; and predicting the action using the data analytics.

In some implementations, the method can include establish communication with at least one component of a monitoring system configured to monitor the property; and accessing, using the communication, property data received from the at least one component of the monitoring system. Determining the one or more actions can include determining one or more events that occurred at the property within a threshold time period of the event by analyzing the property data; using data for the one or more determined events and the detected speech for the event at the property, determining a first action for the event; and selecting, from a plurality of systems that includes a central system, one or more responder systems, and the monitoring system, a system to perform the first action. Performing the one or more actions can include sending an instruction to selected system to cause the selected system to perform the first action.

In some implementations, the determined one or more actions can include an update notification action to be sent to a user interface of a monitoring system of the property. The update notification can include information for actions performed at the property after the event.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The subject matter described in this specification can be implemented in various implementations and may result in one or more of the following advantages. In some implementations, the systems and methods described in this specification can provide actions and/or information, during an emergency situation, using responder data that a central system accesses. This can optimize the execution of actions for the emergency situation compared to other systems. In some implementations, the systems and methods described in this specification can improve security, e.g., security provided for a house or business building, and maintenance of properties compared to other systems by using responder data. For instance, when information from the responder data might not be available otherwise, use of that information can improve security. In some implementations, obtaining responder data as real-time data, or as archived historical data, can support more efficient data processing, reduce data interactions over the network to obtain relevant data for the emergency situation faster, or both. The reduced data interactions can include reduced latency, fewer transmissions, or a combination of both. In some implementations, based on the accessed responder data and detection of speech in the responder data, a system can generate targeted instructions to improve security at properties more accurately, with reduced latency, or both, compared to other systems.

In some implementations, transparency between different systems, for example, with respect to actions executed at one of those systems that is shared with at least one other different system, can be improved compared to scenarios where systems have access to different data sets or do not synchronize or otherwise provide updates between each other. For example, by sharing statuses of execution of actions at one system, such as a responder system, with another system, such as the monitoring system, through providing access to responder data, real-time updates as to the status of an emergency situation can be provided. Such real-time updates might not be provided without the configured methods and systems of the present disclosure. In some cases, providing data analytics over an enhanced set of data can support prompt determination of actions with reduced data transmission and coordinated communication flows between systems and devices. The described methods and systems can support the dynamic generation of instructions to control devices and/or systems for monitoring the property. The generation of instructions can be based on real-time data obtained from different sources and systems so that instructions are provided with reduced latency, and based on relevant data to the particular emergency situation that can be obtained and processed in an automated manner.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram illustrating an example environment of an enhanced central system.

FIG. 2A is a flow diagram of a process for performing actions determined based on detected speech for an event at a property.

FIG. 2B is a flow diagram of a process for determining actions to be performed for an event at a property.

FIG. 2C is a flow diagram of a process for determining actions to be performed for an event at a property based on data obtained from a property data and speech detected for the event from a responder data stream.

FIG. 3 is a diagram illustrating an example of a property monitoring system.

Like reference numbers and designations in the various drawings indicate like elements.

### DETAILED DESCRIPTION

Central systems can interface between property monitoring systems and responder systems. Sometimes, however, the data that a central system has might be incomplete in that the central system might not have certain data related to a property where a monitoring system is installed, while that data may be available or accessible to a responder system associated with the monitoring system. This can cause the central system, the monitoring system, or both, to perform suboptimal actions compared to actions that might otherwise be performed when either or both systems have common access to more data (e.g., access to more responder data available for the responder system).

To enable access and use of this responder data, the central system can access a responder data stream. For instance, the central system can access a wireless responder data stream, e.g., that is part of unencrypted communications between responder devices of the responder system. In some examples, the central system can access a database that maintains data of the responder data stream.

The central system can then use this responder data to determine an action that the central system, the monitoring system, or both, might not otherwise perform. For instance, the central system can trigger an action for the monitoring system to perform that includes accessing additional data for the responder system or a corresponding device (e.g., a responder device connected to the responder system), or a combination of both. In some implementations, the central system can trigger an automated action by the monitoring system, such as unlocking a door at the property, turning lights at the property on or off, or a combination of both. In some implementations, the central system can determine whether to send a notification to a different responder system to perform an action in addition to or instead of the responder system.

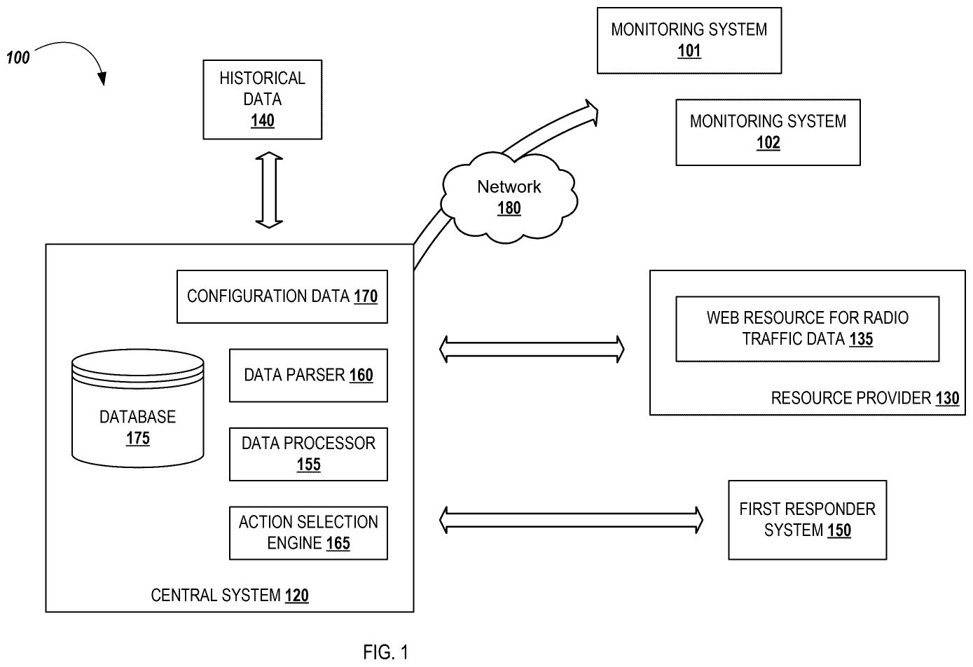

FIG. 1 is a diagram illustrating an example environment 100 of an enhanced central system. A central system 120 can be communicatively coupled to multiple monitoring systems installed for multiple properties (e.g., houses, business buildings, etc.). The central system 120 can be configured to obtain data from the monitoring systems, and from other systems such as responder systems associated with one or more of the properties.

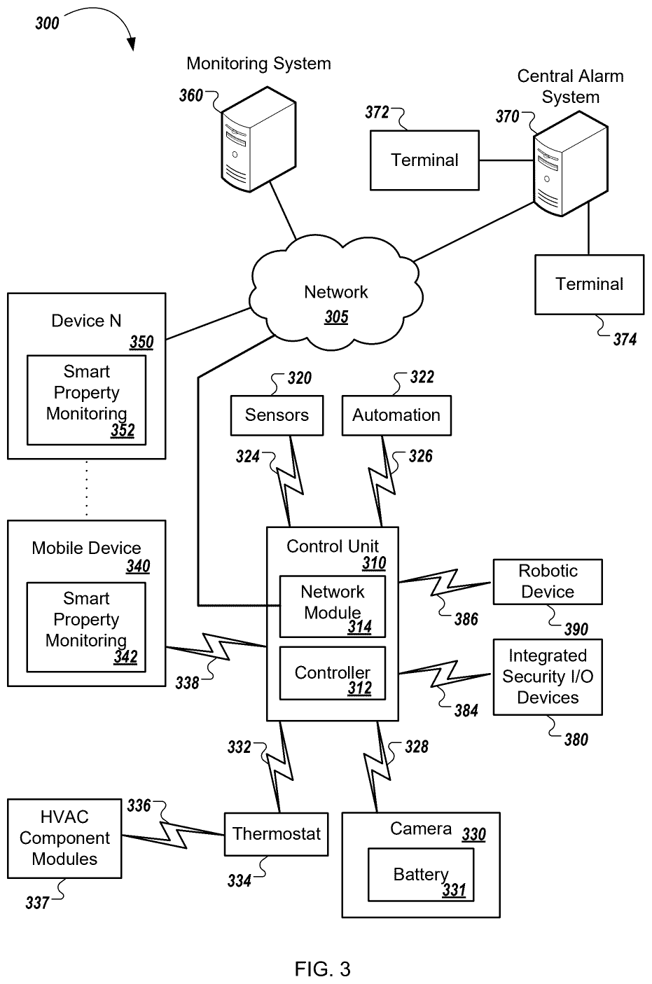

The central system 120 can be configured to operate at the environment 100 that can be an environment for monitoring a property such as the environment 300 of FIG. 3 as described below. The property can be any appropriate type of property, such as a home, a business, or a combination of both, and can be monitored for various events such as a break-in, a fire, or a hazardous accident, among other examples. The environment 100 can include a network 180 and can include monitoring systems 101 and 102 for properties, a first responder system 150, a resource provider 130, and historical data 140. In some implementations, the environment 100 can include multiple devices, such as user devices connected to the various systems, e.g., monitoring system user devices, responder user devices, resource provider user devices, or a combination of these.

In some implementations, the central system 120 can obtain data for alarms raised for events at one or more properties from a respective monitoring system configured for monitoring the property, such as the monitoring systems 101 and 102. The monitoring systems 101 and 102, are installed for respective properties and can be connected to various devices that can run smart property monitoring applications accessed by users to monitor and control the monitoring of a property.

The property can be monitored in an environment including multiple devices and systems that support the monitoring and exchange of communication between devices and systems connected to a network in a substantially similar manner as described in relation to the example of an environment 300 of FIG. 3. The environment 100 can include a control unit system that includes a control unit and sensors that are interconnected with properties and support the monitoring. For example, the sensors include lock sensors, contact sensors, motion sensors, cameras, etc. The central system 120 can be configured to provide alarm monitoring services and exchange communications with components and devices within the environment and set up for monitoring the properties. The central system 120 can be configured to interface with multiple monitoring systems and obtain, process, and/or store event data for alarms at respective properties.

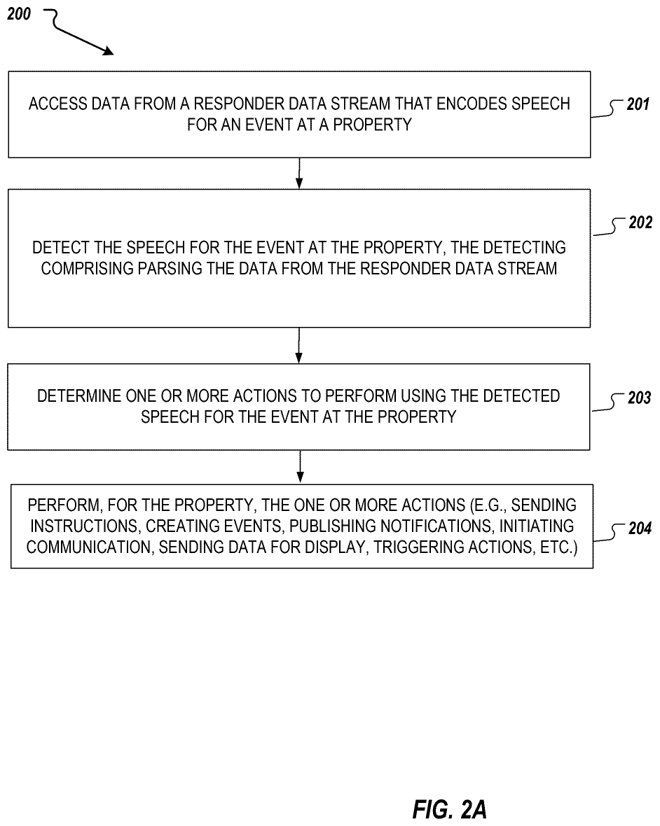

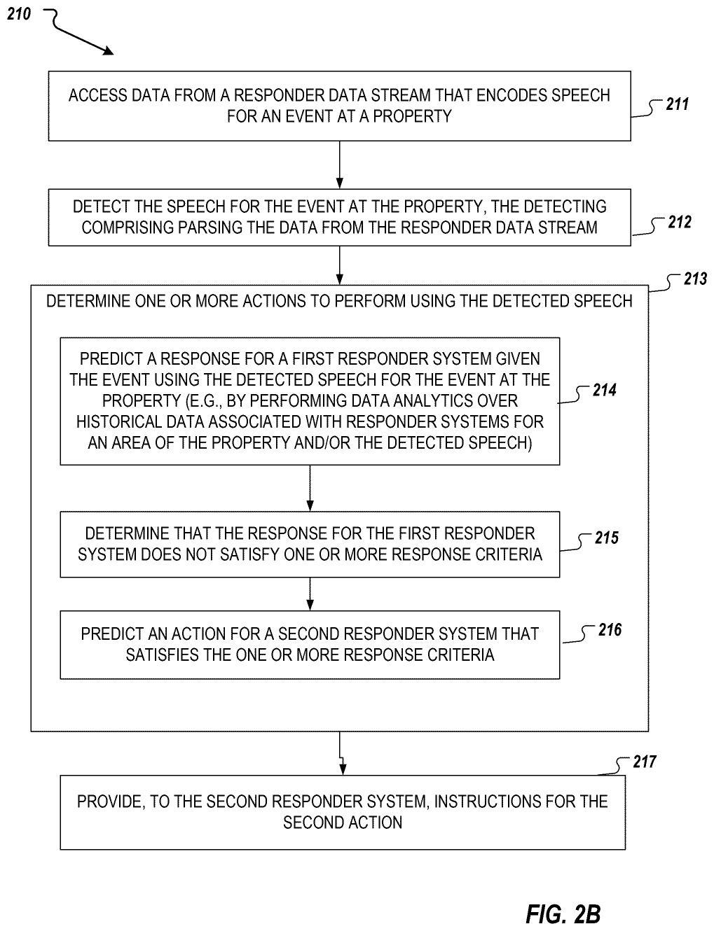

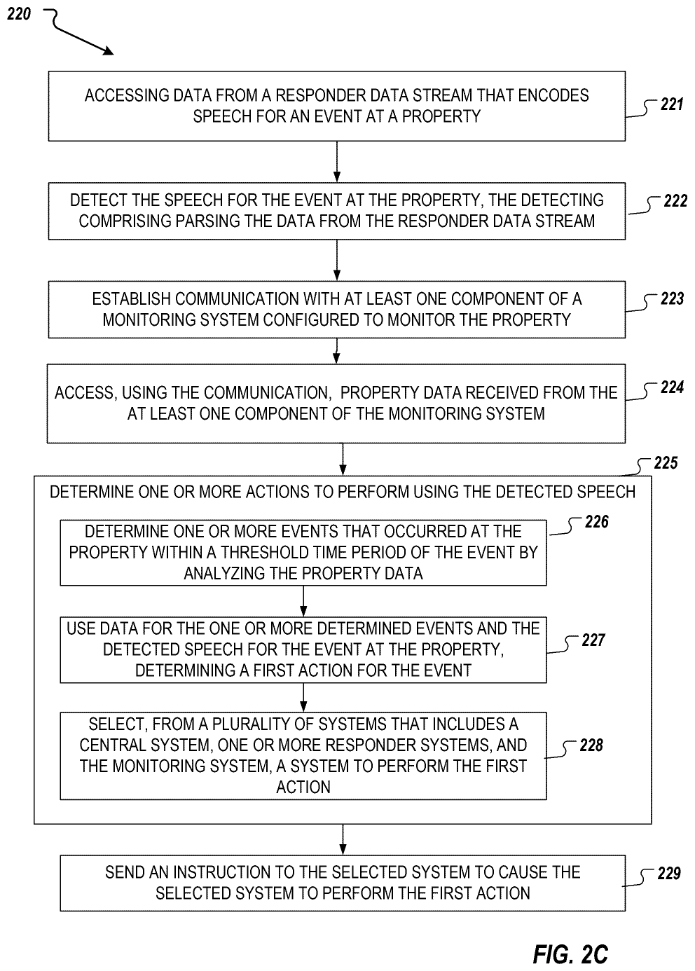

In some implementations, the properties can occupy different geographical regions and different responder systems can be relevant for responders handling events at properties. The central system 120 can be configured to interact with components within the environment 100 in a substantially similar manner to the configuration of the central alarm system 370 of FIG. 3. The central system 120 can be further configured to determine and perform actions based on accessed data from a resource provider 130 as described in the present disclosure. The central system 120 can be configured to implement and execute the processes 200, 210, and 220 of FIGS. 2A, 2B, and 2C.

When the central system 120 receives an alarm raised for an event detected at a property, the central system can obtain responder data; other data dynamically obtained through the monitoring system for the property; or a combination of both. The central system 120 can use the obtained data to determine actions to be performed for the property. For example, the central system 120 can perform an action including providing data associated with the alarm (e.g., a notification, an alert, information, etc.) to one or more responder systems. For example, the central system 120 can receive an alarm raised for an event at a first property from the monitoring system 101. The central system 120 can be configured to provide data for the received alarm to a respective responder system that is determined as relevant for the received alarm. For example, the central system 120 can provide data for the received alarm to a first responder system 150 that is determined as relevant for the alarm (and/or the respective event at the property). In some implementations, the respective responder system can be determined as relevant by determining the data for the alarm and selecting the responder system from multiple responder systems configured to interface with the central system 120. For example, the respective responder system can be selected as matching a type of event that was detected at the property and for which the alarm was sent.

The central system 120 can include configuration data 170 that is defined for use by the central system 120 and its components to perform actions or other appropriate operations. In some implementations, the configuration data 170 can include mapping data that defines the relationship between properties and respective responder systems dedicated to the properties. In some examples, the mapping data can include also mapping of responder systems based on a type of event that is identified at a property.

The central system 120 can be configured to access and process responder data obtained for a resource provider 130, for example, in relation to configured processes for monitoring a property. The central system 120 includes a database 175 to store obtained data from various systems or data sources, and/or to store processed data or log data from past executions that can be used for data analysis and tracking.

The resource provider 130 can provide access to a responder data stream through an interface (such as an application programming interface (API)) exposed for external invocation. In some implementations, the resource provider 130 can be a service that pulls or otherwise obtains radio traffic, transcripts, or other public records from the first responder system 150 (and/or other responder systems) that can be provided as a responder data stream to the central system 120. For instance, a resource provider 130 can include an entity, system, or both, that retrieves responder data from responder systems, e.g., the first responder system 150, and stores that data in memory, e.g., in an archive. The provided responder data stream can include at least in part unencrypted communications between responders of a responder system (e.g., public safety responder system). In some examples, the resource provider can maintain a database of data from the responder data stream. In some implementations, the resource provider 130 can provide a web resource, or another appropriate type of interface, for access to the responder data, e.g., as radio traffic data 135 associated with a responder system, such as the first responder system 150. The resource provider 130 can provide multiple resources including data streams of communication between responders of various responder systems. Although described as a web resource for radio traffic data 135, the data can include other appropriate types of resources for the responder data.

In some implementations, the central system 120 can access data from the web resource for radio traffic data 135 that encodes speech for an event at the property. In some cases, the central system 120 includes a data parser 160 that can be configured to obtain accessed responder data and parse the data to detect speech encoded in the obtained data. Data for the detected speech can be provided for processing to a data processor 155.

In some implementations, the data parser 160 or another component of the central system 120 can determine a likelihood that the detected speech relates to an event. The event can be an event that the central system 120 is monitoring, e.g., for one of the monitoring systems 101-102, as compared to an event for a property that the central system 120 is not monitoring.

The data processor 155 can be configured to analyze the obtained speech and to determine actions to be performed by the central system 120, for example, as described for the determined actions to be performed in FIGS. 2A, 2B, and 2C. In some implementations, the data parser 160 can include transcription logic that generates, from the obtained data stream as an audio stream, transcribed text that includes the speech in text format, e.g., ASCII.

Based on processing obtained data, the speech for the event can be detected through parsing, e.g., by the data parser 160, the obtained data and used to determine actions to be performed for the property at the data processor 155. The data processor 155 can interact with an action selection engine 165 component to determine actions to be performed. In some implementations, the action selection engine 165 component can obtain data from historical data 140 related to one or more responder systems to predict responses of responder systems, to predict actions that can be performed by responder systems, or both, e.g., to optimally determine what actions to perform to improve the security at the monitored property. For example, the central system can determine to perform an action to forward information about the event and/or the property to another responder system, e.g., based on predicting that an action taken by the other responder system can satisfy response criteria (e.g., time threshold) for the event at the property when the initially selected responder system would not satisfy the response criteria, e.g., is delayed. Such determination of another action based on prediction logic and the obtained data from speech between responders of a responder system or other responder data can support a higher security level when monitoring a property and optimizing the performance to protect the property from hazardous events.

In some examples, an alarm can be raised for a fire at the property and the central system 120 can be configured to determine relevant actions to be performed for the fire at the property by analyzing detected speech for the fire event at the property between responders of the first responder system 150. The speech can be detected from a responder data stream that can be obtained from a resource provider, such as the resource provider 130.

In some implementations, the central system 120 can use historical data 140 to determine whether actions to be performed by the first responder system 150 would satisfy a responder criterion (e.g., defined at the configuration data 170 of the central system 120). The historical data 140 can include data previously collected by the central system with regard to previous events at properties, respective actions taken, data collected from responder system related to performed actions, received notifications with regard to events, for example, identified within a geographical area such as a neighborhood, municipality, city, state, or a combination of two or more of these. In some instances, the historical data 140 can include data for triggered alarms for properties and subsequently executed actions or other operations responsive to the triggered alarms. The historical data 140 can include data for events recorded at responder systems or monitoring systems for properties. The historical data 140 can include identification data of property or properties for which alarms are raised or events are tracked; timestamp data for respective alarms or other events; log data for executed actions, operations, or sent instructions; other descriptive data; or combination thereof.

In some implementations, the first responder system 150 can be a system designed to facilitate interaction between devices used by operators, first responders, or both, that perform actions for events that occur at properties. Responder systems can be implemented as computer systems for use by a public safety responder, such as police, safety guards, fire stations, hospitals, emergency care, paramedics, or other emergency associations, among other examples.

In some implementations, the responder data stream can encode the speech of a responder, an operator, or a combination of both. The responder data stream can encode speech in a communication exchanged between one or more responders of one or responder systems. The encoded speech can identify event(s) associated with a raised alert(s) for a property, for example, within a particular area such as a neighborhood or city. For instance, the encoded speech can be of a responder making a statement about the event, e.g., a fire or burglary. When the encoded speech encodes a communication exchange, that exchange can be between the responder and a dispatcher, e.g., as an operator operating a computer in the responder system. In some implementations, the encoded speech can include location identification of a responder that can be used to determine the distance between the location of the responder and the location of the event (e.g., properties' location, or more specific location such as a location of the backyard or parking lot).

In some implementations, the central system 120 can detect speech encoded within the data that is for the event and use the detected speech to determine one or more actions to be performed. For example, the determined actions can include sending instructions to the monitoring system of the property or to other responder systems, generating report data to be provided to a designated entity, sending notifications including information for the event determined from the detected speech, or a combination of two or more of these. In some examples, if an alarm is raised for a fire at the property, the central system 120 can receive data identifying the alarm from a monitoring system installed for the property and can access data from a responder data stream from the resource provider 130 to determine actions to be performed for the property. The accessed responder data stream can be a data stream associated with responders of the first responder system 150 that are associated with the property (e.g., the first responder system 150 is defined as the relevant system for handling the event at the property). In some implementations, based on processing the data from the responder data stream and detecting speech related to the event at the property, the central system 120 can send an alarm to a second responder system for emergency care (e.g., send an alarm to a hospital system in addition to the alarm being set to a fire station system).

The central system 120 can automate the execution of operations to reduce network traffic and automatically obtain data relevant to an event so that actions to reduce risks of property damage and human suffering can be determined in a fast and accurate manner. The central system 120 can be configured to automatically obtain responder data streams and match it with events at properties, so that the obtained data is processed according to data processing logic as implemented at the data processor 155.

The central system 120 is an example of a system implemented as computer programs on one or more computers in one or more locations, in which the systems, components, and techniques described in this specification are implemented. In some examples, the central system 120 can be implemented, at least in part, by a monitoring system. The network 180, such as a local area network (“LAN”), wide area network (“WAN”), the Internet, or a combination thereof, can connect devices and systems such as the central system 120, the monitoring systems 101 and 102, the first responder system 150, and the resource provider 130. The environment 100 can also include devices connected through the network 180 to one or more of the systems. The devices can include personal computers, mobile communication devices, and other devices that can send and receive data over the network 180.

The central system 120 can include several different functional components, including the data parser 160, the data processor 155, and the action selection engine 165. One or more of these components can include one or more data processing apparatuses, can be implemented in code, or a combination of both. For instance, each of the components of the central system 120 can include one or more data processors and instructions that can cause the one or more data processors to perform the operations discussed herein.

The various functional components of the central system 120 can be installed on one or more computers as separate functional components or as different modules of the same functional component. For example, the data parser 160, the data processor 155, and the action selection engine 165 can be implemented as computer programs installed on one or more computers, in one or more locations that are coupled to each through a network. In cloud-based systems, for example, these components can be implemented by individual computing nodes of a distributed computing system.

FIG. 2A is a flow diagram of a process 200 for performing actions determined based on detected speech for an event at a property. The process 200 can be executed at a central system that is communicatively coupled to monitoring systems for properties and responder systems configured to perform action related to events identified at one or more of the properties. For example, the process 200 can be performed by the central system 120 from the environment 100 of FIG. 1.

At 201, data from a responder data stream can be accessed. The responder data stream can be a data stream that encodes speech for one or more events at respective properties. The responder data stream can be provided by a resource provider system such as the resource provider 130 of FIG. 1. The resource provider system be configured to receive the responder data between user devices of a responder system, thus, to compile and broadcast, or otherwise provide the compiled data for consumption by external components, for example, the central system. The responder data can be traffic data that includes data exchanged between communication endpoints over a radio frequency or another form of communication channel. The communication channel can be an unencrypted communication channel that is publicly available.

The resource provider system can be configured to provide responder data for consumption by external entities, for example, an application or a system such as the central system 120 of FIG. 1. In some implementations, the resource provider system can be a web application or system that provides radio traffic through an exposed application interface. In some cases, the provided data can be processed at a transcription service (provided at the resource provider system, as an intermediate external service to the central system, or as part of the central system) so that speech can be received in text format. The resource provider system can provide data from a response provider in real time or close to real time, or as archived data that can be accessed at a later point in time.

In some implementations, the data from the responder data stream can include data related to an event at a property that has a monitoring system (e.g., monitoring system 101 or 102) configured to interact with a central system, such as the central system 120 of FIG. 1. In some implementations, the responder data stream includes speech for one or more events associated with properties that are monitored. For example, a responder system can be a system provided for use by an authority such as a public safety provider or a police office. In these examples, users of the responder system can interact through user devices connected to the responder system and exchange messages (e.g., audio and/or video messages), or other data in relation to various events or actions including events at properties within a geographical area (e.g., districts, city, neighborhood, community, other). Traffic data generated between devices of responders of the responder system can be collected by the resource provider and provided for access to the central system. A resource provider can be substantially similar to the resource provider 130 of FIG. 1. In some implementations, a central system configured to monitor properties where monitoring systems are installed can obtain the data from the responder data stream to acquire data related to alarms raised at properties. For example, the central system can receive an alarm for an event at a property that had been triggered by a monitoring system of the property. The central system can obtain data from the responder system and detect speech for the event at the property.

In some implementations, the process 200 can include the determination of a time stamp of the event for the property. For example, a central system can receive information for alarms triggered by monitoring systems and can process the information to identify time points when events had been registered for properties by the monitoring system. In some implementations, a monitoring system can trigger an alarm for a property based on determining that an event has happened at a property (e.g., detected smoke in a room, movement in a room without unlocking the property, etc.). The central system can obtain information about the event from the monitoring system. For example, the central system can access, e.g., pull or otherwise request, information from the monitoring system, such as, at regular intervals, or can receive the information as provided by the monitoring system, in response to the triggered alarm. The monitoring system of a property can include a component, such as a notification component, that provides information about triggered alarms to the central system. The obtained information about the event can include a time stamp of the event that can be determined by the central system when the information is received.

The determined time stamp can be used to identify the data to be accessed from the responder data stream at 201. In some implementations, based on determining a time stamp of an event for a property, the time stamp can be used to determine a time range around the event as a period of time for which data from a responder data stream may be relevant. As such, the time stamp can be used to determine a relevant time range (e.g., according to a predefined rule for determining the relevant time range such as 15 minutes before and after the time stamp of the event) to access data associated with encoded speech within the relevant time range.

At 202, the speech for the event, as in the accessed data from the responder data stream, can be detected. The accessed data can be parsed to determine speech that is associated with the event. For example, the user of a responder system, such as a police officer, exchanges communication through a user's device to inform about details associated with the event at the property. A parser can parse the responder data stream to detect the encoding of the police officer's speech.

At 203, one or more actions are determined to be performed with regard to the event at the property. The one or more actions are determined using the detected speech for the event at the property. In some implementations, the determination of the actions to be performed may be based on a type of event that occurs at the property. The type of the event can be determined by analyzing the detected speech for the event at the property, sensor data for the property, or both. The sensor data can be data that triggered the alarm or other data for the property, e.g., where people are located at the property.

The event at the property can be an emergency situation and can be categorized into a certain type from a set of predefined types. For example, events can be categorized based on their severity and impact on the property, other objects associated with the property (e.g., house residents, animals, surrounding area, etc.), or a combination of both. An action, an object as a designated target for the action, or both, can be determined using the type of the event at the property. For example, based on determining that the event is an emergency situation of fire in the property that imposes life risk to the property occupants, a first action can be determined to send a notification to a fire emergency system, for example, by sending a voice message with details for the property and the event to a communication interface provided by the fire emergency system. In these examples, the fire emergency system and the respective communication interface that can be invoked are determined as the designated target for the first action of sending a notification message.

At 204, the determined one or more actions are performed for the property. The performed action can include providing instructions to another system, for example, associated with another responder, providing notifications to a user interface of a central system, to a monitoring system of the relevant property associated with the event, or a combination of these. The monitoring system can initiate communication with other systems, applications, or components, triggering actions to be performed by other systems, providing data to other systems, etc.

In some implementations, the process 200 can include additional operations, fewer operations, or some of the operations can be divided into multiple operations. In some implementations, when an alarm is raised by a monitoring system for an event at a property and information is exchanged with a responder system, for example, a public safety responder system, information about the status of the event can be provided by a central system that manages the information flow from multiple monitoring systems and that implements the process 200, so that one of the determined actions for the event can be to provide an update to the monitoring system of the property where the event is registered, another property, or both. The other property can be within a threshold distance of the property. The update can then be provided to a user device can associated with the monitoring system. For example, the execution of the action to provide an update can include providing a notification to a user interface of the monitoring system. For example, a user device of an owner or manager of the property can include a user interface that can receive notifications directed to the monitoring system. In some implementations, the action that is performed can be to provide an update notification to the monitoring system that includes a status of the event at the property based on information obtained through the detected speech. For example, a message part of the speech detected from the responder data stream can be a real-time data stream of traffic data exchanged between responders for the event at the property. The provided update notification can include information for actions performed at the property after the event has been notified to the responder system. For example, the data stream from the responder system can include speech related to actions that are requested to be executed by other objects, such as sending instructions from the responder system to another system of a different responder so that the other system performs actions for the event at the property.

In some implementations, a central system can receive a message that indicates an event at the property and includes an identifier for the property that has a monitoring system. Such message can be received in parallel, e.g., in part, or sequentially, e.g., before, with the accessing of data from a responder data stream at 201. Based on the received indication of the event and an identifier of the property, a responder system relevant to the property can be determined. The central system can maintain data that includes mapping between properties and relevant responder systems for the properties (e.g., relevant for one or more type of events that can be determined at the properties). In some implementations, a responder system for the property can be determined, by the central system, by using the identifier for the property. Actions can be determined for that responder system as described in relation to the operation 203. The actions can be determined by processing the detected speech and determining an action that would not be otherwise performed by the central system unless the data from the responder data stream had been accessed and the speech was detected. For example, the speech may be processed, and it can be determined that there is a delay in the response time of the responder system. In these examples, based on using the speech that includes messages discussing the delay, another responder system can be identified and an action with regard to the other responder system can be determined and performed. The other responder system can be notified about the event at the property based on performing the actions as determined by the central system.

FIG. 2B is a flow diagram of a process 210 for determining actions to be performed for an event at a property. The process 210 can be implemented to be executed at a central system that is communicatively coupled to monitoring systems of properties, responder systems, and/or other devices or components configured to run in an environment, such as the environment 100 of FIG. 1 or environment 300 of FIG. 3. The process 210 can be configured to be executed at the central system to perform actions related to events identified at one or more of the properties. The process 210 can be executed at a central system substantially similar to the central system 120 of FIG. 1.

In some implementations, a first responder system can be provided with an alarm about the event at the property, for example, by the monitoring system for the property, through the central system, or through another system or device.

At 211, data from a responder data stream can be accessed. The responder data stream can be a data stream that encodes speech for one or more events at respective properties.

At 212, speech for the event is detected at the accessed data. The operations 211 and 212 can be performed as described in relation to FIG. 2A. The responder data stream can be a data stream associated with the first responder system that has been provided with the alarm about the event.

At 213, one or more actions to be performed by the central system are determined by using the detected speech. In some implementations, the central system can process the detected speech to determine information related to the event at the property and to use the information to predict, at 214, a response for the first responder system. For example, the response can be predicted based on an analysis of historical data stored for the first responder system. The historical data can be data such as the historical data 140 of FIG. 1. The historical data can be logged data for previous events at properties to which the first responder system was assigned. Based on the determination of the historical data, a prediction of a response of the first responder system can be made. For example, a response action and expected response time can be predicted.

At 215, the predicted response for the first responder system can be determined to determine whether it satisfies a response criterion defined for the event at the property. For example, the central system can include defined rules based on predefined criteria for responding to events of different types. The criteria can include particular actions for a respective event (e.g., matching an event type or a level of urgency) and/or a response time.

If it is determined that the predicted response by the first responder system does not satisfy a criterion for the response, an action for another second responder system can be predicted, at 216, that can be associated with a response that would satisfy the response criterion. In some implementations, the prediction of the action for the second responder system can be done based on performing data analytics over historical data associated with responder systems, determined as relevant for at least one of the events, property, or the central system. Based on performing the data analytics, the second responder system can be determined as the system that can perform an action that would satisfy the defined response criterion. In some cases, more than one responder system and actions can be predicted based on the historical data analysis and can be provided as options for actions to be instructed by the central system.

At 217, instructions for the second action as predicted are provided to the second responder system by the central system.

FIG. 2C is a flow diagram of a process 220 for determining actions to be performed for an event at a property based on data obtained from property data and speech detected for the event from a responder data stream. The process 220 can be implemented to be executed at a central system that is communicatively coupled to monitoring systems of properties, responder systems, and/or other user devices or components configured to run in an environment such as the environment 100 of FIG. 1 and/or environment 300 of FIG. 3. The process 220 can be configured to be executed at a central system to perform actions related to events identified at one or more of the properties. The process 210 can be executed at a central system substantially similar to the central system 120 of FIG. 1.

At 221, data from a responder data stream can be accessed. The responder data stream can be a data stream that encodes speech of one or more responders for one or more events at respective properties.

At 222, speech for the event is detected at the accessed data. The operations 221 and 222 can be performed as described in relation to operations 201 and 202, and 211 and 212 of FIGS. 2A and 2B. The responder data stream can be a data stream associated with the first responder system that has been provided with the alarm about the event.

At 223, the central system can establish communication with at least one component of the monitoring system configured to monitor the property at which the event has happened. The communication channel can facilitate the exchange of data and/or instructions from the central system to the monitoring system so as to control sensors or devices at the monitored properties (e.g., open locks, turn on cameras, etc.) and obtain data collected by sensors and devices at the property.

At 224, property data received from at least one component of the monitoring system is accessed using the established connection. The at least one component that can provide the property data can include a control unit that can be connected to multiple sensors or devices, or a sensor that can stream sensor readings directly to the central system, among other example components that can provide data to the central system from the monitoring system. In some implementations, the property data can be live data currently obtained at the property after the event had been registered and alarm(s) have been sent, the property data can come from archived data that can be accessed for a past period of time, or both. For example, based on providing a time period around the event at the property, so as to obtain collected data at various locations around and/or within the property.

At 225, one or more actions can be determined by the central system. The one or more actions can be similar or the same as actions determined at operations 203 or 213 at FIGS. 2A and 2B respectively. In some examples, operation 225 can include one or more sub-operations, e.g., operations 226, 227, 228, or a combination of these.

The central system can use any appropriate type of data to determine the one or more actions. For instance, the central system can use the speech data, the property data, the data from other systems or resources, or a combination of two or more of these, to determine the actions. In some instances, the central system can use the data about the property and data for environmental or traffic factors, or both. around the property. The central system can generate, using the data, notifications for transmission to the responder system to provide information about the status of handling an alarm, which has been raised at the property.

In some implementations, the central system can use data from other systems or resources related to the monitored property. The other data can define attributes of the monitored property including environmental factors, e.g., weather conditions, natural disasters, or social events; traffic data, e.g., data from traffic lights, data from traffic cameras, or published resources providing information for traffic jams or specific traffic situations; or a combination of both. In some cases, data from such other systems or resources can be leveraged with data received from a component of the monitoring system to determine actions to be performed by the central system, the monitoring system, or a combination of both. For example, using information about traffic situation from traffic cameras and/or weather conditions, the central system can generate instructions, e.g., for a responder system, that indicate a particular navigation route to the monitored property. The route can be generated using the traffic situation and/or weather to estimate travel time. In some examples, the route can be generated to select a route that facilitates reaching the property from a given starting location of a routed responder to the property in a more efficient way (e.g., less time spent) given a selected mode of transportation between locations (e.g., walking, driving, biking, etc.).

At 226, the obtained data from the property data can be analyzed to determine one or more events that occurred at the property within a threshold time period. The events can be determined according to a pre-defined period of time, around the time of the event, as identified by a recorded timestamp for the event at the property by the monitoring system.

At 227, data for the one or more determined events can be obtained from the property data. The data for the one or more events can be used together with the detected speech for the event, from the responder data stream, to determine a first action to be performed for the event.

At 228, a system to perform the first action can be selected from a plurality of systems including the central system, one or more responder systems, and the monitoring system for the property. In some implementations, the central system can be determined to provide a notification to a user device associated with the monitoring system or to send a request to a responder system.

In some implementations, the monitoring system can be selected as the system to send instructions to sensors or devices in the property. For example, a lock of a back door of the property can be instructed to be unlocked by the monitoring system. The lock can be locked in response to a selection of the monitoring system as the system to perform an action for the property based on used data for the determined event and the speech data.

For example, the event at the property can be a burglary where policemen are sent to the property based on instructions sent to a responder system of the policy for that area. In that example, based on accessed data from the property data, it can be determined that a burglar is currently located on a second floor and another one is at the front door. From the speech data, it can be determined that the policemen are directed to the front door of the house. Based on input from the monitoring system at the house, it can be determined that the front door is obstructed or otherwise not advisable to be used for entering the house. For instance, the burglar is positioned within a threshold distance from the front door that may prevent a policeman from entering, e.g., without being immediately noticed. By using the data from the determined event of the location of the burglars and the directions of the policemen, a determination can be made for another door to be used for entering the house. For example, a selection of the monitoring system can be made so that the monitoring system instructs a lock at a back door of the property to be unlocked so that policemen can enter the property from the back. In some cases, instructions can be sent from the central system to the responder system so that the responder system can send one or more notification to user devices of the policemen. The notifications can include information that the back door is unlocked at the house, that the front door should not be used, or a combination of both. The responder system can send instructions to the user devices to instruct the use of the back door for entering the house and to provide information about the current location of the burglars.

At 229, an instruction is sent to the selected system(s) to cause the selected system(s) to perform the first action.

For situations in which the systems discussed here collect personal information about users, or may make use of personal information, the users may be provided with an opportunity to control whether programs or features collect personal information (e.g., information about a user's social actions or activities, a user's preferences, or a user's current location), or to control whether and/or how the systems operate. In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and how that information is used.

In this specification, the term “database” is used broadly to refer to any collection of data: the data does not need to be structured in any particular way, or structured at all, and it can be stored on storage devices in one or more locations. A database can be implemented on any appropriate type of memory.

In this specification the term “engine”, which can include a parser or a data processor, is used broadly to refer to a software-based system, subsystem, or process that is programmed to perform one or more specific functions. Generally, an engine will be implemented as one or more software modules or components, installed on one or more computers in one or more locations. In some instances, one or more computers will be dedicated to a particular engine. In some instances, multiple engines can be installed and running on the same computer or computers.

FIG. 3 is a diagram illustrating an example of an environment 300, e.g., for monitoring a property. The property can be any appropriate type of property, such as a home, a business, or a combination of both. The environment 300 includes a network 305, a control unit 310, one or more devices 340 and 350, a monitoring system 360, a central alarm system 370, or a combination of two or more of these. In some examples, the network 305 facilitates communications between two or more of the control unit 310, the one or more devices 340 and 350, the monitoring system 360, and the central alarm system 370.

The network 305 is configured to enable exchange of electronic communications between devices connected to the network 305. For example, the network 305 can be configured to enable the exchange of electronic communications between the control unit 310, the one or more devices 340 and 350, the monitoring system 360, and the central alarm system 370. The network 305 can include, for example, one or more of the Internet, Wide Area Networks (“WANs”), Local Area Networks (“LANs”), analog or digital wired and wireless telephone networks (e.g., a public switched telephone network (“PSTN”), Integrated Services Digital Network (“ISDN”), a cellular network, and Digital Subscriber Line (“DSL”)), radio, television, cable, satellite, any other delivery or tunneling mechanism for carrying data, or a combination of these. The network 305 can include multiple networks or subnetworks, each of which can include, for example, a wired or wireless data pathway. The network 305 can include a circuit-switched network, a packet-switched data network, or any other network able to carry electronic communications (e.g., data or voice communications). For example, the network 305 can include networks based on the Internet protocol (“IP”), asynchronous transfer mode (“ATM”), the PSTN, packet-switched networks based on IP, X.25, or Frame Relay, or other comparable technologies, that can support voice using, for example, voice over IP (“VoIP”), or other comparable protocols used for voice communications. The network 305 can include one or more networks that include wireless data channels and wireless voice channels. The network 305 can be a broadband network.

The control unit 310 includes a controller 312 and a network module 314. The controller 312 is configured to control a control unit monitoring system, e.g., a control unit system, that includes the control unit 310. In some examples, the controller 312 can include one or more processors or other control circuitry configured to execute instructions of a program that controls the operation of a control unit system. In these examples, the controller 312 can be configured to receive input from sensors, or other devices included in the control unit system and control operations of devices at the property, e.g., speakers, displays, lights, doors, other appropriate devices, or a combination of these. For example, the controller 312 can be configured to control the operation of the network module 314 included in the control unit 310.

The network module 314 is a communication device configured to exchange communications over the network 305. The network module 314 can be a wireless communication module configured to exchange wireless, wired, or a combination of both, communications over the network 305. For example, the network module 314 can be a wireless communication device configured to exchange communications over a wireless data channel and a wireless voice channel. In some examples, the network module 314 can transmit alarm data over a wireless data channel and establish a two-way voice communication session over a wireless voice channel. The wireless communication device can include one or more of a LTE module, a GSM module, a radio modem, a cellular transmission module, or any type of module configured to exchange communications in any appropriate type of wireless or wired format.

The network module 314 can be a wired communication module configured to exchange communications over the network 305 using a wired connection. For instance, the network module 314 can be a modem, a network interface card, or another type of network interface device. The network module 314 can be an Ethernet network card configured to enable the control unit 310 to communicate over a local area network, the Internet, or a combination of both. The network module 314 can be a voice band modem configured to enable the alarm panel to communicate over the telephone lines of Plain Old Telephone Systems (“POTS”).

The control unit system that includes the control unit 310 can include one or more sensors 320. For example, the environment 300 can include multiple sensors 320. The sensors 320 can include a lock sensor, a contact sensor, a motion sensor, a camera (e.g., a camera 330), a flow meter, any other type of sensor included in a control unit system, or a combination of two or more of these. The sensors 320 can include an environmental sensor, such as a temperature sensor, a water sensor, a rain sensor, a wind sensor, a light sensor, a smoke detector, a carbon monoxide detector, or an air quality sensor, to name a few additional examples. The sensors 320 can include a health monitoring sensor, such as a prescription bottle sensor that monitors taking of prescriptions, a blood pressure sensor, a blood sugar sensor, or a bed mat configured to sense presence of liquid (e.g., bodily fluids) on the bed mat. In some examples, the health monitoring sensor can be a wearable sensor that attaches to a person, e.g., a user, at the property. The health monitoring sensor can collect various health data, including pulse, heartrate, respiration rate, sugar or glucose level, bodily temperature, motion data, or a combination of these. The sensors 320 can include a radio-frequency identification (“RFID”) sensor that identifies a particular article that includes a pre-assigned RFID tag.

The control unit 310 can communicate with a module 322 and a camera 330 to perform monitoring. The module 322 is connected to one or more devices that enable property automation, e.g., home or business automation. For instance, the module 322 can connect to, and be configured to control the operation of, one or more lighting systems. The module 322 can connect to, and be configured to control operation of, one or more electronic locks, e.g., control Z-Wave locks using wireless communications in the Z-Wave protocol. In some examples, the module 322 can connect to, and be configured to control the operation of, one or more of the appliances. The module 322 can include multiple sub-modules that are each specific to a type of device being controlled in an automated manner. The module 322 can control the one or more devices using commands received from the control unit 310. For instance, the module 322 can receive a command from the control unit 310, which command was sent using data captured by the camera 330 that depicts an area. In response, the module 322 can cause a lighting system to illuminate an area to provide better lighting in the area, and a higher likelihood that the camera 330 can capture a subsequent image of the area that depicts more accurate data of the area.

The camera 330 can be an image camera or another type of optical sensing device configured to capture one or more images. For instance, the camera 330 can be configured to capture images of an area within a property monitored by the control unit 310. The camera 330 can be configured to capture single, static images of the area; video of the area, e.g., a sequence of images; or a combination of both. The camera 330 can be controlled using commands received from the control unit 310 or another device in the property monitoring system, e.g., a device 350.

The camera 330 can be triggered using any appropriate techniques, can capture images continuously, or a combination of both. For instance, a Passive Infra-Red (“PIR”) motion sensor can be built into the camera 330 and used to trigger the camera 330 to capture one or more images when motion is detected. The camera 330 can include a microwave motion sensor built into the camera which is used to trigger the camera 330 to capture one or more images when motion is detected. The camera 330 can have a “normally open” or “normally closed” digital input that can trigger the capture of one or more images when external sensors detect motion or other events. The external sensors can include another sensor from the sensors 320, PIR, or door or window sensors, to name a few examples. In some implementations, the camera 330 receives a command to capture an image, e.g., when external devices detect motion or another potential alarm event or in response to a request from a device. The camera 330 can receive the command from the controller 312, directly from one of the sensors 320, or a combination of both.

In some examples, the camera 330 triggers integrated or external illuminators to improve image quality when the scene is dark. Some examples of illuminators can include Infra-Red, Z-wave controlled “white” lights, lights controlled by the module 322, or a combination of these. An integrated or separate light sensor can be used to determine if illumination is desired and can result in increased image quality.

The camera 330 can be programmed with any combination of time schedule, day schedule, system “arming state”, other variables, or a combination of these, to determine whether images should be captured when one or more triggers occur. The camera 330 can enter a low-power mode when not capturing images. In this case, the camera 330 can wake periodically to check for inbound messages from the controller 312 or another device. The camera 330 can be powered by internal, replaceable batteries, e.g., if located remotely from the control unit 310. The camera 330 can employ a small solar cell to recharge the battery when light is available. The camera 330 can be powered by a wired power supply, e.g., the controller's 312 power supply if the camera 330 is co-located with the controller 312.

In some implementations, the camera 330 communicates directly with the monitoring system 360 over the network 305. In these implementations, image data captured by the camera 330 need not pass through the control unit 310. The camera 330 can receive commands related to operation from the monitoring system 360, provide images to the monitoring system 360, or a combination of both.

The environment 300 can include one or more thermostats 334, e.g., to perform dynamic environmental control at the property. The thermostat 334 is configured to monitor the temperature of the property, energy consumption of a heating, ventilation, and air conditioning (“HVAC”) system associated with the thermostat 334, or both. In some examples, the thermostat 334 is configured to provide control of environmental (e.g., temperature) settings. In some implementations, the thermostat 334 can additionally or alternatively receive data relating to activity at a property; environmental data at a property, e.g., at various locations indoors or outdoors or both at the property; or a combination of both. The thermostat 334 can measure or estimate energy consumption of the HVAC system associated with the thermostat. The thermostat 334 can estimate energy consumption, for example, using data that indicates the usage of one or more components of the HVAC system associated with the thermostat 334. The thermostat 334 can communicate various data, e.g., temperature, energy, or both, with the control unit 310. In some examples, the thermostat 334 can control the environment, e.g., temperature, and settings in response to commands received from the control unit 310.

In some implementations, the thermostat 334 is a dynamically programmable thermostat and can be integrated with the control unit 310. For example, the dynamically programmable thermostat 334 can include the control unit 310, e.g., as an internal component to the dynamically programmable thermostat 334. In some examples, the control unit 310 can be a gateway device that communicates with the dynamically programmable thermostat 334. In some implementations, the thermostat 334 is controlled via one or more modules 322.

The environment 300 can include the HVAC system or otherwise be connected to the HVAC system. For instance, the environment 300 can include one or more HVAC modules 337. The HVAC modules 337 can be connected to one or more components of the HVAC system associated with a property. A module 337 can be configured to capture sensor data from, control operation of, or both, corresponding components of the HVAC system. In some implementations, the module 337 is configured to monitor the energy consumption of an HVAC system component, for example, by directly measuring the energy consumption of the HVAC system components or by estimating the energy usage of the one or more HVAC system components by detecting usage of components of the HVAC system. The module 337 can communicate energy monitoring information, the state of the HVAC system components, or both, to the thermostat 334. The module 337 can control the one or more components of the HVAC system in response to receipt of commands received from the thermostat 334.

In some examples, the environment 300 includes one or more robotic devices 390. The robotic devices 390 can be any type of robots that are capable of moving, such as an aerial drone, a land-based robot, or a combination of both. The robotic devices 390 can take actions, such as capture sensor data, or other actions that assist in security monitoring, property automation, or a combination of both. For example, the robotic devices 390 can include robots capable of moving throughout a property using automated navigation control technology, user input control provided by a user, or a combination of both. The robotic devices 390 can fly, roll, walk, or otherwise move about the property. The robotic devices 390 can include helicopter type devices (e.g., quad copters), rolling helicopter type devices (e.g., roller copter devices that can fly and roll along the ground, walls, or ceiling), and land vehicle type devices (e.g., automated cars that drive around a property). In some examples, the robotic devices 390 can be robotic devices 390 that are intended for other purposes and merely associated with the environment 300 for use in appropriate circumstances. For instance, a robotic vacuum cleaner device can be associated with the environment 300 as one of the robotic devices 390 and can be controlled to take action responsive to monitoring system events.

In some examples, the robotic devices 390 automatically navigate within a property. In these examples, the robotic devices 390 include sensors and control processors that guide the movement of the robotic devices 390 within the property. For instance, the robotic devices 390 can navigate within the property using one or more cameras, one or more proximity sensors, one or more gyroscopes, one or more accelerometers, one or more magnetometers, a global positioning system (“GPS”) unit, an altimeter, one or more sonar or laser sensors, any other types of sensors that aid in navigation about a space, or a combination of these. The robotic devices 390 can include control processors that process output from the various sensors and control the robotic devices 390 to move along a path that reaches the desired destination, avoids obstacles, or a combination of both. In this regard, the control processors detect walls or other obstacles in the property, and guide movement of the robotic devices 390 in a manner that avoids the walls and other obstacles.

In some implementations, the robotic devices 390 can store data that describes attributes of the property. For instance, the robotic devices 390 can store a floorplan, a three-dimensional model of the property, or a combination of both, that enables the robotic devices 390 to navigate the property. During initial configuration, the robotic devices 390 can receive the data describing attributes of the property, determine a frame of reference to the data (e.g., a property or reference location in the property), and navigate the property using the frame of reference and the data describing attributes of the property. In some examples, the initial configuration of the robotic devices 390 can include learning one or more navigation patterns in which a user provides input to control the robotic devices 390 to perform a specific navigation action (e.g., fly to an upstairs bedroom and spin around while capturing video and then return to a property charging base). In this regard, the robotic devices 390 can learn and store the navigation patterns such that the robotic devices 390 can automatically repeat the specific navigation actions upon a later request.

In some examples, the robotic devices 390 can include data capture devices. In these examples, the robotic devices 390 can include, as data capture devices, one or more cameras, one or more motion sensors, one or more microphones, one or more biometric data collection tools, one or more temperature sensors, one or more humidity sensors, one or more airflow sensors, any other type of sensor that can be useful in capturing monitoring data related to the property and users in the property, or a combination of these. The one or more biometric data collection tools can be configured to collect biometric samples of a person in the property with or without contact of the person. For instance, the biometric data collection tools can include a fingerprint scanner, a hair sample collection tool, a skin cell collection tool, or any other tool that allows the robotic devices 390 to take and store a biometric sample that can be used to identify the person (e.g., a biometric sample with DNA that can be used for DNA testing).

In some implementations, the robotic devices 390 can include output devices. In these implementations, the robotic devices 390 can include one or more displays, one or more speakers, or any other type of output devices that allow the robotic devices 390 to communicate information, e.g., to a nearby user or another type of person, or a combination of these.

The robotic devices 390 can include a communication module that enables the robotic devices 390 to communicate with the control unit 310, each other, other devices, or a combination of these. The communication module can be a wireless communication module that allows the robotic devices 390 to communicate wirelessly. For instance, the communication module can be a Wi-Fi module that enables the robotic devices 390 to communicate over a local wireless network at the property. Other types of short-range wireless communication protocols, such as 900 MHz wireless communication, Bluetooth, Bluetooth LE, Z-wave, Zigbee, Matter, or any other appropriate type of wireless communication, can be used to allow the robotic devices 390 to communicate with other devices, e.g., in or off the property. In some implementations, the robotic devices 390 can communicate with each other or with other devices of the environment 300 through the network 305.

The robotic devices 390 can include processor and storage capabilities. The robotic devices 390 can include any one or more suitable processing devices that enable the robotic devices 390 to execute instructions, operate applications, perform the actions described throughout this specification, or a combination of these. In some examples, the robotic devices 390 can include solid-state electronic storage that enables the robotic devices 390 to store applications, configuration data, collected sensor data, any other type of information available to the robotic devices 390, or a combination of two or more of these.

The robotic devices 390 can process captured data locally, provide captured data to one or more other devices for processing, e.g., the control unit 310 or the monitoring system 360, or a combination of both. For instance, the robotic device 390 can provide the images to the control unit 310 for processing. In some examples, the robotic device 390 can process the images to determine an identification of the items.

One or more of the robotic devices 390 can be associated with one or more charging stations. The charging stations can be located at a predefined home base or reference location in the property. The robotic devices 390 can be configured to navigate to one of the charging stations after completion of one or more tasks needed to be performed, e.g., for the environment 300. For instance, after completion of a monitoring operation or upon instruction by the control unit 310, a robotic device 390 can be configured to automatically fly to and connect with, e.g., land on, one of the charging stations. In this regard, a robotic device 390 can automatically recharge one or more batteries included in the robotic device 390, so that the robotic device 390 is less likely to need recharging when the environment 300 requires use of the robotic device 390, e.g., absent other concerns for the robotic device 390.

The charging stations can be contact-based charging stations, wireless charging stations, or a combination of both. For contact-based charging stations, the robotic devices 390 can have readily accessible points of contact to which a robotic device 390 can contact on the charging station. For instance, a helicopter type robotic device can have an electronic contact on a portion of its landing gear that rests on and couples with an electronic pad of a charging station when the helicopter type robotic device lands on the charging station. The electronic contact on the robotic device 390 can include a cover that opens to expose the electronic contact when the robotic device is charging and closes to cover and insulate the electronic contact when the robotic device 390 is in operation.

For wireless charging stations, the robotic devices 390 can charge through a wireless exchange of power. In these implementations, a robotic device 390 needs only TO position itself closely enough to a wireless charging station for the wireless exchange of power to occur. In this regard, the positioning needed to land at a predefined home base or reference location in the property that can be less precise than with a contact-based charging station. Based on the robotic devices 390 landing at a wireless charging station, the wireless charging station can output a wireless signal that the robotic device 390 receives and converts to a power signal that charges a battery maintained on the robotic device 390. As described in this specification, a robotic device 390 landing, or coupling with a charging station can include a robotic device 390 positioning itself within a threshold distance of a wireless charging station such that the robotic device 390 is able to charge its battery.

In some implementations, one or more of the robotic devices 390 has an assigned charging station. In these implementations, the number of robotic devices 390 can equal the number of charging stations. In these implementations, the robotic devices 390 can always navigate to the specific charging station assigned to that robotic device 390. For instance, a first robotic device can always use a first charging station, and a second robotic device can always use a second charging station.

In some examples, the robotic devices 390 can share charging stations. For instance, the robotic devices 390 can use one or more community charging stations that are capable of charging multiple robotic devices 390, e.g., substantially concurrently or separately, or a combination of both at different times. The community charging station can be configured to charge multiple robotic devices 390 at substantially the same time, e.g., the community charging station can begin charging a first robotic device and then, while charging the first robotic device, begin charging a second robotic device five minutes later. The community charging station can be configured to charge multiple robotic devices 390 in serial such that the multiple robotic devices 390 take turns charging and, when fully charged, return to a predefined home base or reference location or another location in the property that is not associated with a charging station. The number of community charging stations can be less than the number of robotic devices 390.

In some implementations, the charging stations might not be assigned to specific robotic devices 390 and can be capable of charging any of the robotic devices 390. In this regard, the robotic devices 390 can use any suitable, unoccupied charging station when not in use, e.g., when not performing an operation for the environment 300. For instance, when one of the robotic devices 390 has completed an operation or is in need of battery charge, the control unit 310 can reference a stored table of the occupancy status of each charging station and instructs the robotic device to navigate to the nearest charging station that has at least one unoccupied charger.

The environment 300 can include one or more integrated security devices 380. The one or more integrated security devices can include any type of device used to provide alerts based on received sensor data. For instance, the one or more control units 310 can provide one or more alerts to the one or more integrated security input/output devices 380. In some examples, the one or more control units 310 can receive sensor data from the sensors 320 and determine whether to provide an alert, or a message to cause a presentation of an alert, to the one or more integrated security input/output devices 380.

The sensors 320, the module 322, the camera 330, the thermostat 334, the module 337, the integrated security devices 380, and the robotic devices 390, can communicate with the controller 312 over communication links 324, 326, 328, 332, 336, 338, 384, and 386. The communication links 324, 326, 328, 332, 336, 338, 384, and 386 can be a wired or wireless data pathway configured to transmit signals between any combination of the sensors 320, the module 322, the camera 330, the thermostat 334, the module 337, the integrated security devices 380, the robotic devices 390, or the controller 312. The sensors 320, the module 322, the camera 330, the thermostat 334, the module 337, the integrated security devices 380, and the robotic devices 390, can continuously transmit sensed values to the controller 312, periodically transmit sensed values to the controller 312, or transmit sensed values to the controller 312 in response to a change in a sensed value, a request, or both. In some implementations, the robotic devices 390 can communicate with the monitoring system 360 over network 305. The robotic devices 390 can connect and communicate with the monitoring system 360 using a Wi-Fi or a cellular connection or any other appropriate type of connection.

The communication links 324, 326, 328, 332, 336, 338, 384, and 386 can include any appropriate type of network, such as a local network. The sensors 320, the module 322, the camera 330, the thermostat 334, the robotic devices 390 and the integrated security devices 380, and the controller 312 can exchange data and commands over the network.

The monitoring system 360 can include one or more electronic devices, e.g., one or more computers. The monitoring system 360 is configured to provide monitoring services by exchanging electronic communications with the control unit 310, the one or more devices 340 and 350, the central alarm system 370, or a combination of these, over the network 305. For example, the monitoring system 360 can be configured to monitor events (e.g., alarm events) generated by the control unit 310. In these examples, the monitoring system 360 can exchange electronic communications with the network module 314 included in the control unit 310 to receive information regarding events (e.g., alerts) detected by the control unit 310. The monitoring system 360 can receive information regarding events (e.g., alerts) from the one or more devices 340 and 350.

In some implementations, the monitoring system 360 might be configured to provide one or more services other than monitoring services. In these implementations, the monitoring system 360 might perform one or more operations described in this specification without providing any monitoring services, e.g., the monitoring system 360 might not be a monitoring system as described in the example shown in FIG. 3.

In some examples, the monitoring system 360 can route alert data received from the network module 314, or the one or more devices 340 and 350 to the central alarm system 370. For example, the monitoring system 360 can transmit the alert data to the central alarm system 370 over the network 305.

The monitoring system 360 can store sensor and image data received from the environment 300 and perform analysis of sensor and image data received from the environment 300. Based on the analysis, the monitoring system 360 can communicate with and control aspects of the control unit 310 or the one or more devices 340 and 350.

The monitoring system 360 can provide various monitoring services to the environment 300. For example, the monitoring system 360 can analyze the sensor, image, and other data to determine an activity pattern of a person of the property monitored by the environment 300. In some implementations, the monitoring system 360 can analyze the data for alarm conditions or can determine and perform actions at the property by issuing commands to one or more components of the environment 300, possibly through the control unit 310.

The central alarm system 370 is an electronic device, or multiple electronic devices, configured to provide alarm monitoring service by exchanging communications with the control unit 310, the one or more mobile devices 340 and 350, the monitoring system 360, or a combination of these, over the network 305. For example, the central alarm system 370 can be configured to monitor alerting events generated by the control unit 310. In these examples, the central alarm system 370 can exchange communications with the network module 314 included in the control unit 310 to receive information regarding alerting events detected by the control unit 310. The central alarm system 370 can receive information regarding alerting events from the one or more mobile devices 340 and 350, the monitoring system 360, or both.

The central alarm system 370 is connected to multiple terminals 372 and 374. The terminals 372 and 374 can be used by operators to process alerting events. For example, the central alarm system 370, e.g., as part of a first responder system, can route alerting data to the terminals 372 and 374 to enable an operator to process the alerting data. The terminals 372 and 374 can include general-purpose computers (e.g., desktop personal computers, workstations, or laptop computers) that are configured to receive alerting data from a computer in the central alarm system 370, and render a display of information using the alerting data.

For instance, the controller 312 can control the network module 314 to transmit to the central alarm system 370, alerting data indicating that a sensor 320 detected motion from a motion sensor via the sensors 320. The central alarm system 370 can receive the alerting data and route the alerting data to the terminal 372 for processing by an operator associated with the terminal 372. The terminal 372 can render a display to the operator that includes information associated with the alerting event (e.g., the lock sensor data, the motion sensor data, the contact sensor data, etc.) and the operator can handle the alerting event based on the displayed information. In some implementations, the terminals 372 and 374 can be mobile devices or devices designed for a specific function. Although FIG. 3 illustrates two terminals for brevity, actual implementations can include more (and, perhaps, many more) terminals.

The one or more devices 340 and 350 are devices that can present content, e.g., host and display user interfaces, audio data, or both. For instance, the mobile device 340 is a mobile device that hosts or runs one or more native applications (e.g., the smart property application 342). The mobile device 340 can be a cellular phone or a non-cellular locally networked device with a display. The mobile device 340 can include a cell phone, a smart phone, a tablet PC, a personal digital assistant (“PDA”), or any other portable device configured to communicate over a network and present information. The mobile device 340 can perform functions unrelated to the monitoring system, such as placing personal telephone calls, playing music, playing video, displaying pictures, browsing the Internet, and maintaining an electronic calendar.

The mobile device 340 can include a smart property application 342. The smart property application 342 refers to a software/firmware program running on the corresponding mobile device that enables the user interface and features described throughout. The mobile device 340 can load or install the smart property application 342 using data received over a network or data received from local media. The smart property application 342 enables the mobile device 340 to receive and process image and sensor data from the monitoring system 360.

The device 350 can be a general-purpose computer (e.g., a desktop personal computer, a workstation, or a laptop computer) that is configured to communicate with the monitoring system 360, the control unit 310, or both, over the network 305. The device 350 can be configured to display a smart property user interface 352 that is generated by the device 350 or generated by the monitoring system 360. For example, the device 350 can be configured to display a user interface (e.g., a web page) generated using data provided by the monitoring system 360 that enables a user to perceive images captured by the camera 330, reports related to the monitoring system, or both. Although FIG. 3 illustrates two devices for brevity, actual implementations can include more (and, perhaps, many more) or fewer devices.

In some implementations, the one or more devices 340 and 350 communicate with and receive data from the control unit 310 using the communication link 338. For instance, the one or more devices 340 and 350, can communicate with the control unit 310 using various wireless protocols, or wired protocols such as Ethernet and USB, to connect the one or more devices 340 and 350 to the control unit 310, e.g., local security and automation equipment. The one or more devices 340 and 350 can use a local network, a wide area network, or a combination of both, to communicate with other components in the environment 300. The one or more devices 340 and 350 can connect locally to the sensors and other devices in the environment 300.

Although the one or more devices 340 and 350 are shown as communicating with the control unit 310, the one or more devices 340 and 350, can communicate directly with the sensors and other devices controlled by the control unit 310. In some implementations, the one or more devices 340 and 350, replace the control unit 310 and perform one or more of the functions of the control unit 310 for local monitoring and long range, offsite, or both, communication.

In some implementations, the one or more devices 340 and 350, receive monitoring system data captured by the control unit 310 through the network 305. The one or more devices 340 and 350 can receive the data from the control unit 310 through the network 305, and the monitoring system 360 can relay data received from the control unit 310 to the one or more devices 340 and 350, through the network 305, or a combination of both. In this regard, the monitoring system 360 can facilitate communication between the one or more devices 340 and 350 and various other components in the environment 300.

In some implementations, the one or more devices 340 and 350 can be configured to switch whether the one or more devices 340 and 350 communicate with the control unit 310 directly (e.g., through communication link 338) or through the monitoring system 360 (e.g., through network 305) based on a location of the one or more devices 340 and 350. For instance, when the one or more devices 340 and 350 are located close to, e.g., within a threshold distance of, the control unit 310 and in range to communicate directly with the control unit 310, the one or more devices 340 and 350 use direct communication. When the one or more devices 340 and 350 are located far from, e.g., outside the threshold distance of, the control unit 310, and not in range to communicate directly with the control unit 310, the one or more devices 340 and 350 use communication through the monitoring system 360.

Although the one or more devices 340 and 350 are shown as being connected to the network 305, in some implementations, the one or more devices, 340 and 350, are not connected to the network 305. In these implementations, the one or more devices 340 and 350 communicate directly with one or more of the monitoring system components, and no network (e.g., Internet) connection or reliance on remote servers is needed.

In some implementations, the one or more devices 340 and 350, are used in conjunction with only local sensors and/or local devices in a house. In these implementations, the environment 300 includes the one or more devices, 340 and 350, the sensors 320, the module 322, the camera 330, and the robotic devices 390. The one or more devices 340 and 350 receive data directly from the sensors 320, the module 322, the camera 330, the robotic devices 390, or a combination of these, and send data directly to the sensors 320, the module 322, the camera 330, the robotic devices 390, or a combination of these. The one or more devices 340 and 350 can provide the appropriate interface, processing, or both, to provide visual surveillance and reporting using data received from the various other components.

In some implementations, the environment 300 includes the network 305 and the sensors 320, the module 322, the camera 330, the thermostat 334, and the robotic devices 390 are configured to communicate to the sensor and image data to the one or more devices 340 and 350 over network 305. In some implementations, the sensors 320, the module 322, the camera 330, the thermostat 334, and the robotic devices 390 are programmed, e.g., intelligent enough, to change the communication pathway from a direct local pathway when the one or more devices 340 and 350 are in close physical proximity to the sensors 320, the module 322, the camera 330, the thermostat 334, the robotic devices 390, or a combination of these, to a pathway over the network 305 when the one or more devices 340 and 350 are farther from the sensors 320, the module 322, the camera 330, the thermostat 334, the robotic devices 390, or a combination of these.

In some examples, the monitoring system 360 leverages GPS information from the one or more devices 340 and 350, to determine whether the one or more devices 340 and 350 are close enough to the sensors 320, the module 322, the camera 330, the thermostat 334, the robotic devices 390, or a combination of these, to use the direct local pathway or whether the one or more devices 340 and 350 are far enough from the sensors 320, the module 322, the camera 330, the thermostat 334, the robotic devices 390, or a combination of these, that the pathway over network 305 is required. In some examples, the monitoring system 360 leverages status communications (e.g., pinging) between the one or more devices 340 and 350 and the sensors 320, the module 322, the camera 330, the thermostat 334, the robotic devices 390, or a combination of these, to determine whether communication using the direct local pathway is possible. If communication using the direct local pathway is possible, the one or more devices 340 and 350 communicate with the sensors 320, the module 322, the camera 330, the thermostat 334, the robotic devices 390, or a combination of these, using the direct local pathway. If communication using the direct local pathway is not possible, the one or more devices 340 and 350 communicate with the sensors 320, the module 322, the camera 330, the thermostat 334, the robotic devices 390, or a combination of these, using the pathway over the network 305.

In some implementations, the environment 300 provides people with access to images captured by the camera 330 to aid in decision-making. The environment 300 can transmit the images captured by the camera 330 over a network, e.g., a wireless WAN, to the devices 340 and 350. Because transmission over a network can be relatively expensive, the environment 300 can use several techniques to reduce costs while providing access to significant levels of useful visual information (e.g., compressing data, down-sampling data, sending data only over inexpensive LAN connections, or other techniques).

In some implementations, a state of the environment 300, one or more components in the environment 300, and other events sensed by a component in the environment 300, can be used to enable/disable video/image recording devices (e.g., the camera 330). In these implementations, the camera 330 can be set to capture images on a periodic basis when the alarm system is armed in an “away” state, set not to capture images when the alarm system is armed in a “stay” state or disarmed, or a combination of both. In some examples, the camera 330 can be triggered to begin capturing images when the control unit 310 detects an event, such as an alarm event, a door-opening event for a door that leads to an area within a field of view of the camera 330, or motion in the area within the field of view of the camera 330. In some implementations, the camera 330 can capture images continuously, but the captured images can be stored or transmitted over a network when needed.

Although FIG. 3 depicts the monitoring system 360 as remote from the control unit 310, in some examples the control unit 310 can be a component of the monitoring system 360. For instance, both the monitoring system 360 and the control unit 310 can be physically located at a property that includes the sensors 320, or at a location outside the property.

In some examples, some of the sensors 320, the robotic devices 390, or a combination of both, might not be directly associated with the property. For instance, a sensor or a robotic device might be located at an adjacent property or on a vehicle that passes by the property. A system at the adjacent property or for the vehicle, e.g., that is in communication with the vehicle or the robotic device, can provide data from that sensor or robotic device to the control unit 310, the monitoring system 360, or a combination of both.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, a data processing apparatus. Alternatively, or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application-specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, a component, a subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application-specific integrated circuit (“ASIC”).

Computers suitable for the execution of a computer program include, by way of example, general or special purpose microprocessors or both, or any other kind of central processing unit. Generally, a central processing unit will receive instructions and data from a read-only memory or a random access memory, or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computer-readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by or incorporated into special purpose logic circuitry.

To provide for interaction with a user, implementations of the subject matter described in this specification can be implemented on a computer having a display device, e.g., a liquid crystal display (“LCD”), an organic light emitting diode (“OLED”), or another monitor for displaying information to the user, a keyboard, and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a web browser, through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of a client and server arises by virtue of computer programs running on the respective computers and having a client-server relationship to each other. In some implementations, a server transmits data, e.g., a Hypertext Markup Language (“HTML”) page, to a user device, e.g., for purposes of displaying data to and receiving user input from a user device, which acts as a client. Data generated at the user device, e.g., a result of user interaction with the user device, can be received from the user device at the server.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, and even initially claimed as such, one or more features from a claimed combination can in some implementations be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed to achieve desirable results. In certain circumstances, multitasking and parallel processing may be advantageous. Moreover, the separation of various system modules and components in the implementations described above, should not be understood as requiring such separation in all implementations, and it should be understood that the described program components and systems can generally be integrated together into a single software product or packaged into multiple software products.

Particular implementations of the invention have been described. Other implementations are within the scope of the following claims. For example, the operations recited in the claims, described in the specification, or depicted in the figures can be performed in a different order and still achieve desirable results. In some implementations, multitasking and parallel processing may be advantageous.

### Examples

Although the present application is defined in the attached claims, it should be understood that the present invention can also (additionally or alternatively) be defined in accordance with the following examples:

Example 1. A computer implemented method comprising:
accessing data from a responder data stream that encodes speech for an event at a property;
detecting the speech for the event at the property, the detecting comprising parsing the data from the responder data stream;
determining one or more actions to perform using the detected speech for the event at the property; and
performing, for the property, the one or more actions.

Example 2. The method of Example 1, wherein determining the one or more actions to perform comprises:
determining a type of the event at the property; and
in response to determining the type of the event, determining, using the type of the event, i) a first action of the one or more actions to be performed for the property and ii) an object as a designated target for the first action.

Example 3. The method of any one of the preceding Examples, wherein accessing the data from the responder data stream that encodes the speech for the event comprises:
determining a time stamp of the event for the property, the time stamp being obtained from a component of a monitoring system at the property; and
identifying the data to be accessed as data within a predefined time range around the time stamp of the event.

Example 4. The method of any one of the preceding Examples, comprising:
receiving a message that indicates the event at the property and includes an identifier for the property that has a monitoring system; and
determining a responder system for the property using the identifier for the property, wherein:
   determining the one or more actions to perform comprises determining, using the detected speech for the event at the property, a first action for the responder system to perform in response to the event; and
   performing the one or more actions for the property comprises sending an instruction to the responder system to cause the responder system to perform the first action that would not otherwise be performed by the responder system.

Example 5. The method of any one of the preceding Examples, comprising:
providing, to a first responder system, an alarm about the event,
wherein determining the one or more actions comprises
   predicting a response for the first responder system given the event using the detected speech for the event at the property,
   determining that the response for the first responder system does not satisfy one or more response criteria,
   in response to determining that the response for the first responder system does not satisfy the one or more response criteria, predicting an action for a second responder system that satisfies the one or more response criteria, and
   providing, to the second responder system, instructions for the first action.

Example 6. The method of Example 5, wherein predicting the action comprises:
performing data analytics over historical data associated with responder systems designated for an area that includes the property and the detected speech for the event at the property; and
   predicting the action using the data analytics.

Example 7. The method of any one of the preceding Examples, comprising:
establish communication with at least one component of a monitoring system configured to monitor the property; and
accessing, using the communication, property data received from the at least one component of the monitoring system, wherein:
   determining the one or more actions comprises:
      determining one or more events that occurred at the property within a threshold time period of the event by analyzing the property data;
      using data for the one or more determined events and the detected speech for the event at the property, determining a first action for the event; and
      selecting, from a plurality of systems that includes a central system, one or more responder systems, and the monitoring system, a system to perform the first action; and
   performing the one or more actions comprises sending an instruction to selected system to cause the selected system to perform the first action.

Example 8. The method of any one of the preceding Examples, wherein the determined one or more actions include an update notification action to be sent to a user interface of a monitoring system of the property, the update notification including information for actions performed at the property after the event.

Example 9. One or more computer storage media encoded with instructions that, when executed by one or more computers, cause the one or more computers to perform the method of any preceding Example.

Example 10. A system comprising one or more computers and one or more storage devices on which are stored instructions that are operable, when executed by the one or more computers, to cause the one or more computers to perform the method of any of Examples 1 to 8.

1. A computer implemented method comprising:
accessing data from a responder data stream that encodes speech for an event at a property;
detecting the speech for the event at the property, the detecting comprising parsing the data from the responder data stream;
determining one or more actions to perform using the detected speech for the event at the property; and
performing, for the property, the one or more actions.

2. The method of claim 1, wherein determining the one or more actions to perform comprises:
determining a type of the event at the property; and
in response to determining the type of the event, determining, using the type of the event, i) a first action of the one or more actions to be performed for the property and ii) an object as a designated target for the first action.

3. The method of claim 1, wherein accessing the data from the responder data stream that encodes the speech for the event comprises:
determining a time stamp of the event for the property, the time stamp being obtained from a component of a monitoring system at the property; and
identifying the data to be accessed as data within a predefined time range around the time stamp of the event.

4. The method of claim 1, comprising:
receiving a message that indicates the event at the property and includes an identifier for the property that has a monitoring system; and
determining a responder system for the property using the identifier for the property, wherein:
determining the one or more actions to perform comprises determining, using the detected speech for the event at the property, a first action for the responder system to perform in response to the event; and
performing the one or more actions for the property comprises sending an instruction to the responder system to cause the responder system to perform the first action that would not otherwise be performed by the responder system.

5. The method of claim 1, comprising:
providing, to a first responder system, an alarm about the event,
wherein determining the one or more actions comprises
predicting a response for the first responder system given the event using the detected speech for the event at the property,
determining that the response for the first responder system does not satisfy one or more response criteria,
in response to determining that the response for the first responder system does not satisfy the one or more response criteria, predicting a first action for a second responder system that satisfies the one or more response criteria, and
providing, to the second responder system, instructions for the first action.

6. The method of claim 5, wherein predicting the first action comprises:
performing data analytics over historical data associated with responder systems designated for an area that includes the property and the detected speech for the event at the property; and
predicting the first action using the data analytics.

7. The method of claim 1, comprising:
establish communication with at least one component of a monitoring system configured to monitor the property; and
accessing, using the communication, property data received from the at least one component of the monitoring system, wherein:
determining the one or more actions comprises:
determining one or more events that occurred at the property within a threshold time period of the event by analyzing the property data;
using data for the one or more determined events and the detected speech for the event at the property, determining a first action for the event; and
selecting, from a plurality of systems that includes a central system, one or more responder systems, and the monitoring system, a system to perform the first action; and
performing the one or more actions comprises sending an instruction to selected system to cause the selected system to perform the first action.

8. The method of claim 1, wherein the determined one or more actions include an update notification action to be sent to a user interface of a monitoring system of the property, the update notification including information for actions performed at the property after the event.

9. A non-transitory computer-readable storage media encoding with instructions that, when executed by one or more computers, cause the one or more computers to perform operations comprising:
accessing data from a responder data stream that encodes speech for an event at a property;
detecting the speech for the event at the property, the detecting comprising parsing the data from the responder data stream;
determining one or more actions to perform using the detected speech for the event at the property; and
performing, for the property, the one or more actions.

10. The computer-readable storage media of claim 9, wherein determining the one or more actions to perform comprises:
determining a type of the event at the property; and
in response to determining the type of the event, determining, using the type of the event, i) a first action of the one or more actions to be performed for the property and ii) an object as a designated target for the first action.

11. The non-transitory computer-readable storage media of claim 9, wherein accessing the data from the responder data stream that encodes the speech for the event comprises:
determining a time stamp of the event for the property, the time stamp being obtained from a component of a monitoring system at the property; and
identifying the data to be accessed as data within a predefined time range around the time stamp of the event.

12. The non-transitory computer-readable storage media of claim 9, wherein the operations comprise:
receiving a message that indicates the event at the property and includes an identifier for the property that has a monitoring system; and
determining a responder system for the property using the identifier for the property, wherein:
determining the one or more actions to perform comprises determining, using the detected speech for the event at the property, a first action for the responder system to perform in response to the event; and
performing the one or more actions for the property comprises sending an instruction to the responder system to cause the responder system to perform the first action that would not otherwise be performed by the responder system.

13. The computer-readable storage media of claim 9, wherein the operations comprise:
providing, to a first responder system, an alarm about the event,
wherein determining the one or more actions comprises
predicting a response for the first responder system given the event using the detected speech for the event at the property,
determining that the response for the first responder system does not satisfy one or more response criteria,
in response to determining that the response for the first responder system does not satisfy the one or more response criteria, predicting a first action for a second responder system that satisfies the one or more response criteria, and
providing, to the second responder system, instructions for the first action.

14. The non-transitory computer-readable storage media of claim 13, wherein predicting the first action comprises:
performing data analytics over historical data associated with responder systems designated for an area that includes the property and the detected speech for the event at the property; and
predicting the first action using the data analytics.

15. A system comprising:
one or more computers; and
one or more storage devices on which are stored instructions that are operable, when executed by the one or more computers, to cause the one or more computers to perform operations comprising:
accessing data from a responder data stream that encodes speech for an event at a property;
detecting the speech for the event at the property, the detecting comprising parsing the data from the responder data stream;
determining one or more actions to perform using the detected speech for the event at the property; and
performing, for the property, the one or more actions.

16. The system of claim 15, wherein determining the one or more actions to perform comprises:
determining a type of the event at the property; and
in response to determining the type of the event, determining, using the type of the event, i) a first action of the one or more actions to be performed for the property and ii) an object as a designated target for the first action.

17. The system of claim 15, wherein accessing the data from the responder data stream that encodes the speech for the event comprises:
determining a time stamp of the event for the property, the time stamp being obtained from a component of a monitoring system at the property; and
identifying the data to be accessed as data within a predefined time range around the time stamp of the event.

18. The system of claim 15, wherein the operations comprise:
receiving a message that indicates the event at the property and includes an identifier for the property that has a monitoring system; and
determining a responder system for the property using the identifier for the property, wherein:
determining the one or more actions to perform comprises determining, using the detected speech for the event at the property, a first action for the responder system to perform in response to the event; and
performing the one or more actions for the property comprises sending an instruction to the responder system to cause the responder system to perform the first action that would not otherwise be performed by the responder system.

19. The system of claim 15, wherein the operations comprise:
providing, to a first responder system, an alarm about the event,
wherein determining the one or more actions comprises
predicting a response for the first responder system given the event using the detected speech for the event at the property,
determining that the response for the first responder system does not satisfy one or more response criteria,
in response to determining that the response for the first responder system does not satisfy the one or more response criteria, predicting a first action for a second responder system that satisfies the one or more response criteria, and
providing, to the second responder system, instructions for the first action.

20. The system of claim 19, wherein predicting the first action comprises:
performing data analytics over historical data associated with responder systems designated for an area that includes the property and the detected speech for the event at the property; and
predicting the first action using the data analytics.
